(19) United States
(12) Patent Application Publication
(10) Pub. No.: US 2020/0080567 A1
(43) Pub. Date: Mar. 12, 2020

(54) ALTERNATOR COOLING FAN WITH ADJUSTABLE PITCH

(71) Applicant: DENSO International America, Inc., Southfield, MI (US)

(72) Inventors: Gregory LEWANDOWSKI, Plymouth, MI (US); Cristian BUIA, Madison Heights, MI (US)

(21) Appl. No.: 16/129,167

(22) Filed: Sep. 12, 2018

(51) Int. Cl. F04D 29/36; F04D 27/00

(52) U.S. Cl. CPC F04D 29/368; F04D 27/002; F05D 2260/74; F05D 2220/764; F05D 2260/79; F05D 2220/766; F05D 2260/71

(57) ABSTRACT

A cooling fan for an alternator. The cooling fan has a fan body and a plurality of fan blades extending from the fan body. A hinge is located where each one of the fan blades meets the fan body. The hinge allows the plurality of fan blades to pivot relative to the fan body. The degree of pivot is proportional to rotational speed of the fan body.

### FIELD

The present disclosure relates to an alternator cooling fan including fan blades with an adjustable pitch.

### BACKGROUND

This section provides background information related to the present disclosure, which is not necessarily prior art.

Alternators are widely used electrical generators for converting mechanical energy to electrical energy in the form of alternating current. While current alternators are suitable for their intended use, they are subject to improvement. For example, alternators often include a cooling fan, which may generate excessive noise during operation. An alternator that generates less noise than existing alternators would therefore be desirable. The present disclosure advantageously provides for such an alternator.

### SUMMARY

This section provides a general summary of the disclosure, and is not a comprehensive disclosure of its full scope or all of its features.

The present disclosure includes a cooling fan for an alternator. The cooling fan has a fan body and a plurality of fan blades extending from the fan body. A hinge is located where each one of the fan blades meets the fan body. The hinge allows the plurality of fan blades to pivot relative to the fan body. The degree of pivot is proportional to rotational speed of the fan body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a perspective view of an alternator in accordance with the present disclosure;

FIG. 2 illustrates a fan of the alternator of FIG. 1;

FIG. 3 illustrates a fan blade of the fan in a first position; and

FIG. 4 illustrates the fan blade of the fan in a second position.

Corresponding reference numerals indicate corresponding parts throughout the several views of the drawings.

### DETAILED DESCRIPTION

Example embodiments will now be described more fully with reference to the accompanying drawings.

FIG. 1 illustrates an alternator 10 in accordance with the present disclosure. The alternator 10 can be any suitable alternator that converts mechanical energy to electrical energy in the form of alternating current. For example, the alternator 10 may be configured for use with a vehicle to charge the vehicle's battery and power the electrical system when the engine is running. The alternator 10 can be configured for use with any suitable vehicle, such as any suitable passenger vehicle, mass transit vehicle, recreational vehicle, utility vehicle, construction vehicle/equipment, military vehicle/equipment, watercraft, aircraft, etc. The alternator 10 may be configured for use with any suitable non-vehicular application as well, such as any suitable electrical generator.

The alternator 10 generally includes a stator 12 and a rotor 14. The stator 12 is a stationary set of conductors wound in coils on a core, such as an iron core. The rotor 14 is a rotating magnet that turns within the stator 12. An electrical current is induced in the stator 12 by the rotating magnetic field of the rotor 14. The magnetic field of the rotor 14 may be produced by permanent magnets, or by a field coil electromagnet. With respect to automotive applications, a rotor winding may be used, which allows control of the voltage generated by the alternator 10 by varying the current in the rotor field winding.

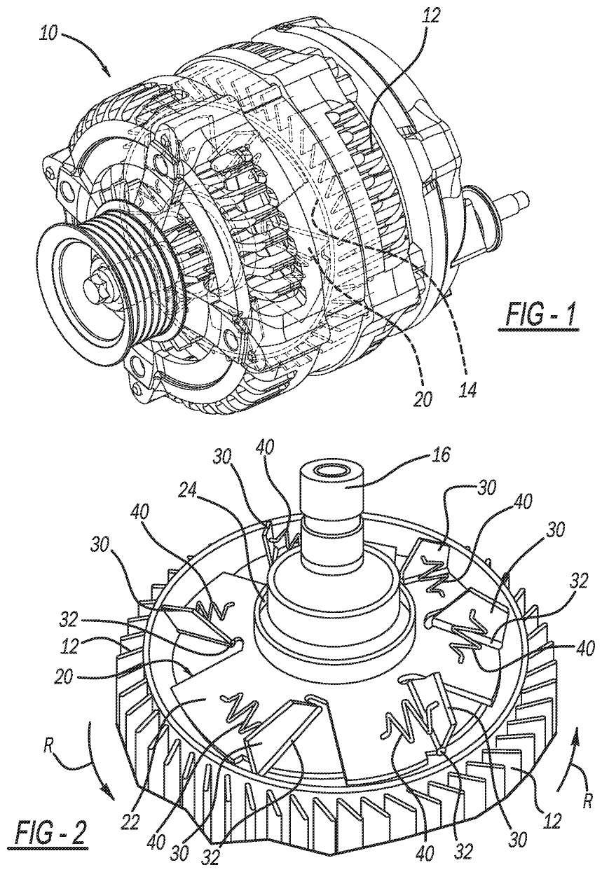

The alternator 10 further includes a cooling fan 20 for cooling components of the alternator 10 during operation. The cooling fan 20 may be attached directly to the rotor 14 such that the cooling fan 20 rotates with the rotor 14. With continued reference to FIG. 1 and additional reference to FIG. 2, additional features of the cooling fan 20 will now be described. The cooling fan 20 includes a fan body 22, which defines an opening 24 at an axial center thereof. A shaft 16 of the rotor 14 extends through the opening 24.

The cooling fan 20 includes a plurality of fan blades 30, which extend from the fan body 22. The fan blades 30 mate with the fan body 22 at hinges 32. The fan blades 30 may be made of the same material as the rest of the fan body 22, or may be made of any other suitable material. For example, the fan blades 30 may be made of any suitable metallic material or any suitable polymeric material. The hinges 32 advantageously allow the fan blades 30 to pivot relative to the fan body 22. The degree of pivot is proportional to the rotational speed of the fan body 22 as the fan body 22 rotates in rotational direction R, which as illustrated in the example of FIG. 2 is counterclockwise. The hinges 32 may be any suitable type of hinge, such as a living hinge, a rod and pinion hinge, etc.

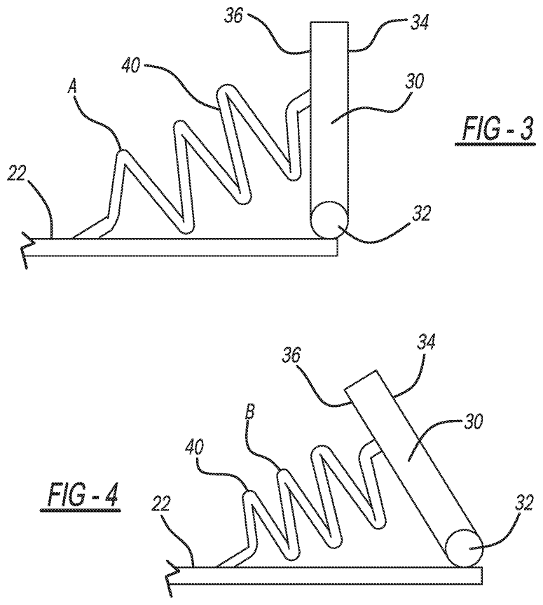

The cooling fan 20 further includes a plurality of pitch control members 40, which regulate the degree of pivot of the fan blades 30. The pitch control members 40 extend from the fan body 22 to different ones of the fan blades 30. Specifically and with reference to FIGS. 3 and 4, each one of the fan blades 30 includes an upstream side 34 and a downstream side 36. The upstream side 34 is “upstream” relative to the downstream side 36 with respect to the direction of rotation R of the fan body 22.

The pitch control members 40 may exert force upon the fan blades 30 in a direction away from the fan body 22. The pitch control members 40 may be springs and/or made of any suitable elastic material, such as any suitable elastomeric polymer, effective to support the fan blades 30 generally upright when the fan body 22 is not rotating, as illustrated in FIG. 3 (see position A of FIG. 3, for example). During rotation of the fan body 22, airflow contacting the upstream side 34 will push (and the pitch control members 40 will allow the fan blades 30 to be pushed) towards the fan body 22 to reduce the angle of the fan blades 30 relative to the fan body 22 as illustrated in FIG. 4. The angle of the pivot or pitch of the fan blades 30 relative to the fan body 22 varies (and is proportional to) the rotational speed of the fan body 22. Thus as the fan body 22 rotates faster, the fan blades 30 will pivot further towards the fan body 22, and compress the pitch control member 40, for example (see position B of FIG. 4, for example). As the fan body 22 rotates relatively slower, the pitch control member 40 will push the fan blades 30 away from the fan body 22.

The pitch control members 40 may include a temperature sensitive material having a rigidity that varies in response to temperature changes. Any suitable temperature sensitive material may be used, such as any suitable temperature sensitive polymer. The temperature sensitive material becomes relatively less rigid and more flexible at relatively cooler temperatures, and becomes relatively more rigid and less flexible at relatively warmer temperatures. Thus at relatively warmer temperatures at which additional cooling is required, the pitch control member 40 will support the fan blades 30 relatively more upright such that the fan blades 30 are more effective to generate airflow for cooling. At relatively cooler temperatures at which less cooling airflow is needed, the temperature sensitive material of the pitch control member 40 will be less rigid and more flexible to allow the fan blades 30 to rotate/bend further about the hinges 32 towards the fan body 22, thereby resulting in the fan blades 30 generating less airflow for cooling.

The present disclosure thus provides numerous advantages over the art. The fan blades 30 are mounted such that at hinges 32 the fan blades 30 pivot to allow the pitch of the fan blades 30 to vary based on the rotational speed of the cooling fan 20. The pitch control members 40 provide a force pushing on the fan blades 30 and controlling the pitch thereof. As the rotor 14 and the fan body 22 attached thereto rotate faster, force exerted on the fan blades 30 causes the pitch control members 40 to compress (see FIG. 4 at B), which varies the pitch of the fan blades 30 and reduces the noise produced by the fan blades 30. A further advantage of the cooling fan 20 is that the pitch control members 40 may include a temperature sensitive material that at relatively cooler temperatures is relatively less rigid and relatively more flexible, which will generate reduced airflow and reduce the noise level of the cooling fan 20. With existing cooling fans, the fan blades are at a fixed pitch, and thus the faster the fan rotates the louder the noise level of the alternator. In contrast, the alternator 10 of the present disclosure provides for fan blades 30 rotatable about hinges 32 to vary the pitch of the fan blades 30 as the rotational speed of the cooling fan 20 changes. By allowing the pitch of the fan blades 30 to vary based on fan speed, the amount of noise and airflow generated by the fan body 22 can be controlled to reduce the noise level and optimize the amount of cooling airflow generated based on the speed of the rotor 14 and the temperature. One skilled in the art will appreciate that the present disclosure provides for numerous additional advantages and unexpected results.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A cooling fan for an alternator, the cooling fan comprising:
a fan body;
a plurality of fan blades extending from the fan body; and
a hinge where each one of the fan blades meets the fan body that allows the plurality of fan blades to pivot relative to the fan body, the degree of pivot is proportional to rotational speed of the fan body;
wherein at a relatively high speed the plurality of fan blades pivot closer to the fan body than at a relatively low speed.

2. The cooling fan of claim 1, wherein the fan body is mounted directly to a rotor of the alternator.

3. The cooling fan of claim 1, wherein a shaft of a rotor extends through an axial center of the fan body.

4. The cooling fan of claim 1, wherein the hinge is a living hinge.

5. The cooling fan of claim 1, wherein the hinge is a rod and pinion hinge.

6. The cooling fan of claim 1, further comprising a plurality of pitch control members, each of which extends from the fan body to a different one of the plurality of fan blades to control the degree of pivot of the plurality of fan blades.

7. The cooling fan of claim 6, wherein the pitch control members extend from the fan body to a downstream side of the plurality of fan blades relative to a rotational direction of the fan body.

8. The cooling fan of claim 6, wherein the pitch control members exert force upon the plurality of fan blades in a direction away from the fan body.

9. The cooling fan of claim 6, wherein the pitch control members include springs.

10. The cooling fan of claim 6, wherein the pitch control members include an elastic material.

11. The cooling fan of claim 6, wherein the pitch control members include a temperature sensitive material having a rigidity that varies in response to temperature changes.

12. The cooling fan of claim 11, wherein rigidity of the temperature sensitive material decreases and flexibility of the temperature sensitive material increases as temperature decreases; and
wherein rigidity of the temperature sensitive material increases and flexibility of the temperature sensitive material decreases as temperature increases.

13. An alternator comprising:
a stator;
a rotor including a shaft, the rotor rotates within the stator;
a fan body defining an opening at an axial center thereof through which the shaft extends, the fan body mounted to the rotor;
a plurality of fan blades extending from the fan body at an angle relative to the fan body;
a hinge where each one of the fan blades meets the fan body that allows the plurality of fan blades to pivot relative to the fan body, the degree of pivot is proportional to rotational speed of the fan body; and
a plurality of pitch control members, each of which extends from the fan body to a downstream side of different ones of the plurality of fan blades, relative to a rotational direction of the fan body, to control the degree of pivot of the plurality of fan blades;
wherein at a relatively high speed the plurality of fan blades are pivoted closer to the fan body than at a relatively low speed.

14. The alternator of claim 13, wherein the hinge is a living hinge.

15. The alternator of claim 13, wherein the hinge is a rod and pinion hinge.

16. The alternator of claim 13, wherein the pitch control members exert force upon the plurality of fan blades in a direction away from the fan body.

17. The alternator of claim 13, wherein the pitch control members include springs.

18. The alternator of claim 13, wherein the pitch control members include an elastic material.

19. The alternator of claim 13, wherein the pitch control members include a temperature sensitive material having a rigidity that varies in response to temperature changes.

20. The alternator of claim 19, wherein rigidity of the temperature sensitive material decreases and flexibility of the temperature sensitive material increases as temperature decreases; and
wherein rigidity of the temperature sensitive material increases and flexibility of the temperature sensitive material decreases as temperature increases.
